(19) United States
(12) Patent Application Publication
(10) Pub. No.: US 2026/0251842 A1
(43) Pub. Date: Aug. 27, 2026

(54) SPECIAL FIBER BUNDLE, OPTICAL RECEIVING SYSTEM BASED ON SPECIAL FIBER BUNDLE, AND LIDAR BASED ON OPTICAL RECEIVING SYSTEM

(71) Applicants: Guilin University of Technology, Guilin (CN); The 34th Research Institute of CETC, Guilin (CN)

(72) Inventors: Guoqing ZHOU, Guilin (CN); Jianyin LIU, Guilin (CN); Xueqin NONG, Guilin (CN); Xiang ZHOU, Guilin (CN); Hui SUN, Guilin (CN); Yi TANG, Guilin (CN); Gang LIANG, Guilin (CN); Tongzhi LIN, Guilin (CN); Jun LIU, Guilin (CN)

(73) Assignees: Guilin University of Technology, Guilin (CN); The 34th Research Institute of CETC, Guilin (CN)

(21) Appl. No.: 19/182,663

(22) Filed: Apr. 18, 2025

(30) Foreign Application Priority Data
Feb. 27, 2025 (CN) 202510227627.9

(51) Int. Cl. G02B 6/028; G01S 7/487; G02B 6/32

(52) U.S. Cl. CPC G02B 6/0288; G01S 7/487; G02B 6/32

(57) ABSTRACT

Provided are a special fiber bundle, an optical receiving system based on the special fiber bundle, and a lidar based on the optical receiving system, relating to the technical field of airborne bathymetric lidar. The special fiber bundle includes an input end, a first output end, and a second output end. The input end is composed of a central multimode fiber, and an annular multimode fiber bundle surrounding the central fiber; the first output end is a central multimode fiber; and the second output end is a circular fiber bundle formed by the annular multimode fiber bundle of the input end. The special fiber bundle, which can replace a field-splitting optical mirror, can separate composite optical echo signals into a large field of view part and a small field of view part

### CROSS-REFERENCE TO RELATED APPLICATION

This patent application claims the benefit and priority of Chinese Patent Application No. 2025102276279 filed with the China National Intellectual Property Administration on Feb. 27, 2025, the disclosure of which is incorporated by reference herein in its entirety as part of the present application.

### TECHNICAL FIELD

The present disclosure relates to the technical field of airborne bathymetric lidar, and in particular to a special fiber bundle, an optical receiving system based on the special fiber bundle, and a lidar based on the optical receiving system.

### BACKGROUND

The airborne bathymetric lidar system is installed on a manned aircraft vehicle (flying at an altitude of 200 m to 1000 m) or an unmanned aerial vehicle (flying at an altitude of 10 m to 50 meter) for flight operation. Emitted pulsed laser beam can scan and cover designated water surface and underwater areas in a point-to-line manner from top to bottom, and optical echo signals diffusely reflected from the water surface and underwater areas are received, stored and processed by an optical receiving system to form a point cloud graph, thus ultimately producing three-dimensional topographic map of the water surface and underwater areas.

Every time a lidar emits a pulsed laser spot, an optical receiving system of the lidar will receive a composite optical echo signal including water surface echo and underwater echo. Due to the significant absorption and scattering of the laser beam by natural water bodies such as rivers, lakes, and oceans, the underwater echo signal is 10³ to 10⁵ times weaker than the water surface echo signal, which may even be much weaker than a scattered light echo caused by water body scattering. To prevent the underwater echo signal from being overwhelmed or avoid difficulty in collecting the underwater echo signal, the optical receiving system of the airborne lidar generally employs a structure composed of a “primary optical receiving lens+field-splitting mirror+optical receiving component with a large-field-of-view channel and a small-field-of-view channel.”

However, this traditional and typical bathymetric optical receiving system with a large-field-of-view channel and a small-field-of-view channel is constrained by the overall system design parameters, it is required that the small-field-of-view optical receiving component and related optical parts are arranged coaxially with the primary optical receiving lens, while the large-field-of-view optical receiving component and related optical parts are arranged perpendicularly with the primary optical receiving lens. The whole optical principal axis structure occupies a certain length and space, which is not conducive to the lightweight and miniaturization of the airborne bathymetric lidar.

### SUMMARY

An objective of the present disclosure is to provide a special fiber bundle, an optical receiving system based on the special fiber bundle, and a lidar based on the optical receiving system. The lightweight and miniaturization of the whole airborne bathymetric lidar can be achieved by replacing a field-splitting optical lens in the optical receiving system with the special fiber bundle.

To achieve the objective above, the present disclosure employs the following technical solution:

In a first aspect, the present disclosure provides a special fiber bundle, including an input end, a first output end, and a second output end.

The input end is composed of a central multimode fiber, and an annular multimode fiber bundle surrounding the central fiber.

The first output end is a central multimode fiber, and the second output end is a circular fiber bundle formed by the annular multimode fiber bundle from the input end.

Alternatively, the central multimode fiber is a single multimode fiber, or a multimode fiber bundle.

Alternatively, when the central multimode fiber is a single multimode fiber, a core diameter of the multimode fiber ranges from 200 μm to 500 μm.

Alternatively, when the central multimode fiber is the multimode fiber bundle, a core diameter of each multimode fiber in the multimode fiber bundle ranges from 100 μm to 300 μm, and the multimode fibers in the multimode fiber bundle have the same core diameter.

Alternatively, a core diameter of each multimode fiber in the annular multimode fiber bundle ranges from 100 μm to 300 μm, and the multimode fibers in the annular multimode fiber bundle have the same core diameter.

Alternatively, the central multimode fiber and multimode fibers in the annular multimode fiber bundle are made of quartz glass.

In a second aspect, the present disclosure provides an optical receiving system based on a special fiber, including a primary optical receiving lens, a special fiber bundle, a small-field-of-view optical receiving component, and a large-field-of-view optical receiving component.

The center of an input end of the special fiber bundle is located at a focal point of the primary optical receiving lens.

A first output end of the special fiber bundle is connected to the small-field-of-view optical receiving component.

A second output end of the special fiber bundle is connected to the large-field-of-view optical receiving component.

Alternatively, the small-field-of-view optical receiving component includes a first collimating lens, a first optical filter, a first focusing lens and a first photodetector in turn along an optical path direction.

Alternatively, the large-field-of-view optical receiving component includes a second collimating lens, a second optical filter, a second focusing lens and a second photodetector along an optical path direction.

In a third aspect, the present disclosure provides a lidar based on an optical receiving system, including an optical receiving system.

The optical receiving system employs a special fiber bundle to replace a field-splitting mirror, a first output end of the special fiber bundle is coupled to an optical receiving component of a small-field-of-view channel, and a second output end of the special fiber bundle is coupled to an optical receiving component of a large-field-of-view channel.

According to specific embodiments of the present disclosure, the present disclosure has the following technical effects:

The present disclosure provides a special fiber bundle, including an input end, a first output end, and a second output end. The input end is composed of a central multimode fiber, and an annular multimode fiber bundle surrounding the central fiber. The first output end is a central multimode fiber; and the second output end is a circular fiber bundle formed by the annular multimode fiber bundle from the input end. The special fiber bundle provided by the present disclosure, which can replace a field-splitting optical mirror, can separate composite optical echo signals into a large field of view part and a small field of view part, thus achieving lightweight and miniaturization of the whole airborne bathymetric lidar.

### BRIEF DESCRIPTION OF THE DRAWINGS

To describe the technical solutions in the embodiments of the present disclosure or the prior art more clearly, a brief introduction of the accompanying drawings required for describing the embodiments will be given below. Apparently, the accompanying drawings in the following description show merely some embodiments of the present disclosure, and those of ordinary skill in the art may still derive other drawings from these accompanying drawings without creative efforts.

FIG. 1A to FIG. 1C are structural diagrams of a special fiber bundle according to an embodiment of the present disclosure;

FIG. 2 is a schematic diagram of a bathymetric optical receiving system with a special fiber bundle for replacing a field-splitting mirror according to an embodiment of the present disclosure;

FIG. 3 is a schematic diagram of an existing optical system according to an embodiment of the present disclosure;

FIG. 4 is a simulation diagram of a water surface detection receiving optical system according to an embodiment of the present disclosure;

FIG. 5 is a simulation diagram of a receiving field of view of a water surface detection receiving optical system according to an embodiment of the present disclosure;

FIG. 6 is a simulation diagram of an underwater detection receiving optical system according to an embodiment of the present disclosure;

FIG. 7 is a diagram of a receiving field of view of an underwater detection receiving optical system according to an embodiment of the present disclosure.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the scope of protection of the present disclosure.

Composite optical echo signals, after being received and focused by a primary optical receiving lens, are separated into two parts: a small field of view ranging from 0 mrad to 5 mrad and a large field of view ranging from 5 mrad to 35 mrad. An amplitude of small-field-of-view optical echo signals accounts for one fifth or less of the total amplitude, and in a shallow water area, a small-field-of-view channel optical receiving component can collect water surface echoes and extremely weak underwater echoes. While an amplitude of large-field-of-view optical echo signals accounts for four-fifths or more of the total amplitude, and a large-field-of-view channel optical receiving component is designed to avoid the water surface optical echoes and only receive the underwater optical echoes from a deep water area.

The composite optical echo signals are divided into a large field of view part and a small field of view part, which is based on a field-splitting optical mirror (i.e., an optical plane mirror with an elliptical hole in the center). The field-splitting optical mirror is located at a focal point of a primary optical receiving lens, and the center of the central elliptical hole coincides with the focal point of the primary lens, and a long axis of the central elliptical hole is placed at 45° with an optical principal axis of an optical receiving system. The composite optical echo signals are focused by the primary optical receiving lens, in which the small-field-of-view optical echo signals form a circular spot with a diameter of Φa on a focal plane of the primary lens, which completely pass through the central elliptical hole of the field-splitting optical mirror (the elliptical hole is designed to have a short axis a and a long axis 1.414a) to enter a coaxial small-field-of-view optical receiving component (as data for measuring water surface and shallow water area), and the large-field-of-view optical echo signals form an annular circular spot with an inner diameter of Φa and an outer diameter of Φb on the focal plane of the primary lens, which is completely outside the central elliptical hole of the field-splitting optical mirror and is reflected to enter a large-field-of-view optical receiving component perpendicular to the optical axis (as data for measuring the deep water area).

The size of the central elliptical hole (short axis a, long axis 1.414a) of the field-splitting optical mirror as well as the size of the elliptical shape (short axis b, long axis 1.414b) are related to design parameters of the whole optical receiving system.

This traditional and typical bathymetric optical receiving system with a large-field-of-view and a small-field-of-view is constrained by the design of the overall parameters, it is required that the small-field-of-view optical receiving component and related optical parts are arranged coaxially with the primary optical receiving lens, while the large-field-of-view optical receiving component and related optical parts are arranged perpendicularly with the primary optical receiving lens.

An objective of the present disclosure is to provide a special fiber bundle, an optical receiving system based on the special fiber bundle, and a lidar based on the optical receiving system. The lightweight and miniaturization of the whole airborne bathymetric lidar can be achieved by replacing a field-splitting optical mirror in the optical receiving system with the special fiber bundle.

To make the objectives, features and advantages of the present disclosure more clearly, the present disclosure is further described in detail below with reference to the accompanying drawings and specific embodiments.

### Embodiment 1

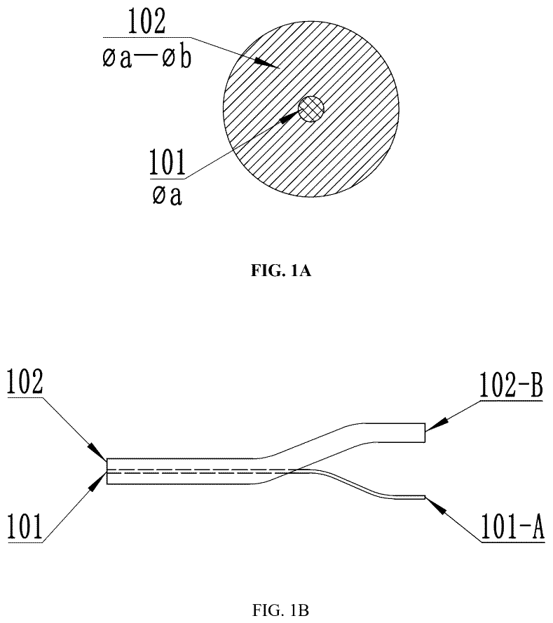

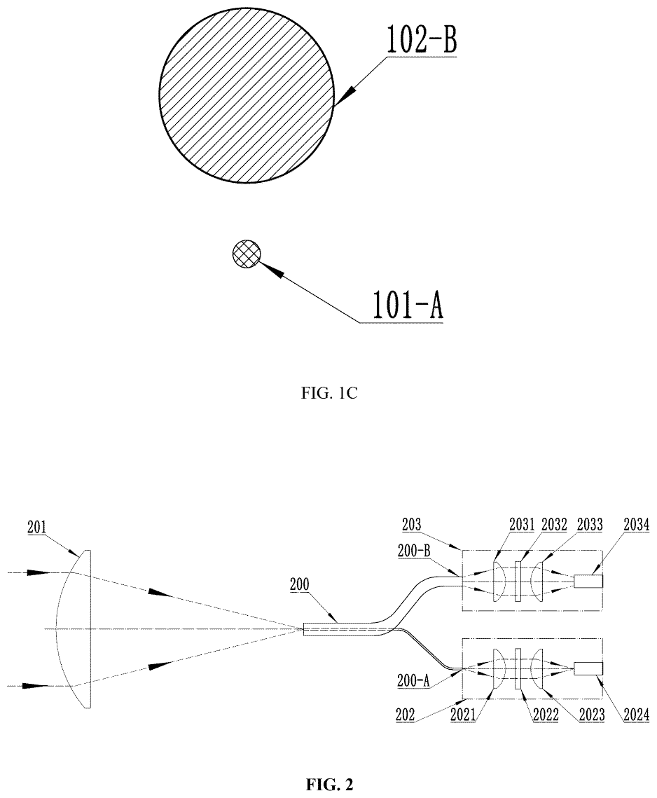

As shown in FIG. 1A to FIG. 1C, this embodiment provides a special fiber bundle, including an input end, a first output end, and a second output end.

The input end is composed of a central multimode fiber, and an annular multimode fiber bundle surrounding the central fiber.

The first output end is the central multimode fiber, and the second output end is a circular fiber bundle formed by the annular multimode fiber bundle from the input end.

The central multimode fiber is a single multimode fiber, or a multimode fiber bundle. When the central multimode fiber is a single multimode fiber, a core diameter of the multimode fiber ranges from 200 μm to 500 μm. When the central multimode fiber is the multimode fiber bundle, a core diameter of each multimode fiber in the multimode fiber bundle ranges from 100 μm to 300 μm, and the multimode fibers in the multimode fiber bundle have the same core diameter. A core diameter of each multimode fiber in the annular multimode fiber bundle ranges from 100 μm to 300 μm, and the multimode fibers in the annular multimode fiber bundle have the same core diameter. The multimode fiber in each of the central multimode fiber and the annular multimode fiber is made of quartz glass.

Specifically, the special fiber bundle is a fiber bundle for replacing a field-splitting mirror. In FIG. 1A, is the input end of the special fiber bundle, the center of a circular end face is a central fiber 101 with a diameter of Φa (a single fiber, or a circular fiber bundle composed of several or tens of fibers with a diameter ranging from 100 μm to 200 μm), and an annular end face in a hatched area is an annular fiber bundle 102 which is composed of tens (or hundreds) of fibers with a core diameter ranging from Φ100 μm to Φ300 μm and has an inner diameter of Φa and an outer diameter of Φb. in FIG. 1C is the output ends of the special fiber bundle, where end A is the first output end, i.e., the central fiber (bundle) 101-A, end B is the second output end, i.e., a circular fiber bundle 102-B (formed by the synthesis of the annular end-face fiber bundle in a hatched area). in FIG. 1B is a schematic diagram of an overall structure of the special fiber bundle.

In this embodiment, the fibers constituting the special fiber bundle are commercially available fibers with large numerical aperture (NA is optional in 0.22, 0.33, 0.47 and 0.66) and large core diameter with thin cladding (core diameter is optional in the range of Φ105 μm to Φ500 μm). The selection of the numerical aperture, core diameter, and the number of fibers is related to the design parameters of the primary optical receiving lens, and the large and small fields of view of the optical receiving system of the whole lidar. The manufacture and production of special fibers can be completed by conventional and mature optical processing technology, and the manufacturing cost is equivalent to that of a high-energy laser mirror with the same caliber.

The commercial fibers have only three low-loss wavelength “windows” for long-distance transmission of the optical signals: 850 nm, 1310 nm and 1550 nm. According to the design requirements of the whole machine, the length of the special fiber bundle is usually 0.2-0.5 m, and the transmission attenuation of 532 nm optical signals outside the low-loss wavelength “windows” can be ignored.

### Embodiment 2

This embodiment provides an optical receiving system based on a special fiber bundle, including a primary optical receiving lens, the special fiber bundle, a small-field-of-view optical receiving component, and a large-field-of-view optical receiving component.

The center of an input end of the special fiber bundle is located at a focal point of the primary optical receiving lens;
a first output end of the special fiber bundle is connected to the small-field-of-view optical receiving component; and
a second output end of the special fiber bundle is connected to the large-field-of-view optical receiving component.

As shown in FIG. 2, a bathymetric optical receiving system based on the special fiber bundle for separating optical echo signals into a large field of view and a small field of view is shown in FIG. 2. The center of the input end of the special fiber bundle 200 is located at the focal point of the primary optical receiving lens 201 (the center of the input end face coincides with the focal plane). Optical echo signals diffusely scattered from a target are received and focused by the primary optical lens 201, where small-field-of-view optical echo signals are focused and coupled into a central fiber (bundle), and finally reach a photodetector 2024 after entering a collimating lens 2021, an optical filter 2022 and a focusing lens 2023 of the small-field-of-view optical receiving component 202 through the output end 200-A; and large-field-of-view optical echo signals are focused and coupled into the annular fiber bundle, and finally reach a photodetector 2034 after entering a collimating lens 2031, an optical filter 2032 and a focusing lens 2033 of the large-field-of-view optical receiving component 203 through the output end 200-B.

The primary optical receiving lens, the small-field-of-view optical receiving component and the large-field-of-view optical receiving component are relatively independent, which form a bathymetric optical receiving system with the special fiber bundle.

### Embodiment 3

This embodiment provides a lidar based on an optical receiving system, including the optical receiving system.

The optical receiving system employs a special fiber bundle to replace a field-splitting mirror, a first output end of the special fiber bundle is coupled to an optical receiving component of a small-field-of-view channel, and a second output end of the special fiber bundle is coupled to an optical receiving component of a large-field-of-view channel.

The rest of the lidar is some existing finished components.

### (1) Laser Device

Lidar usually uses a laser device as a light source to emit a laser beam. The lidar may employ an existing semiconductor laser device or fiber laser device, which has been widely used in various lidar systems, with high stability, high power and low noise.

### (2) Scanning System

The scanning system is configured to change a direction of the laser beam to scan different areas, which can be implemented through mechanical scanning, optical phased array or micro-electromechanical system (MEMS). These technologies are all available and have been widely used in the field of lidar.

### (3) Signal Processing System

The signal processing system is configured to receive and process signals collected by the optical receiving system, which may include a high-speed data acquisition module (AD), a digital signal processor (DSP), or a field programmable gate array (FPGA), and other components. These components can effectively convert an optical signal into a digital signal and filter, amplify and analyze the digital signal for the extraction of useful information.

### (4) Power Management System

The power management system is responsible for providing stable power supply for each component of the lidar, which may include a power converter, a voltage regulator, a battery, and other components. These components are all available and can be selected and configured according to the specific needs of the lidar.

It should be noted that the above is only examples of some existing finished components that may be used in the lidar, and do not constitute a complete lidar system. The actual lidar system may include more components and subsystems.

In addition, the present disclosure further provides an example of a design scheme of a receiving optical system, specifically as follows:

### 1. Design of Receiving Optical System:

### 1.1. Design of Scheme of the Receiving Optical System:

Design requirements are as follows: an optical receiving aperture is about 100 mm, and an optical receiving field of view ranges from 0 mrad to 21 mrad, in which the small field of view ranges from 0 mrad to 5 mrad and the large field of view ranges from 5 mrad to 21 mrad. The optical lens should choose shelf products as far as possible. A photosensitive surface of a water surface photodetector is Φ0.5 mm, and a photosensitive surface of an underwater photodetector is Φ8 mm.

The receiving optical system is mainly configured to complete the reception of ranging laser echo and improve the receiving efficiency, and distinguishing the water surface echo from the underwater echo is the key points in the design of the receiving optical system. To achieve the design requirements of a miniaturized, lightweight, and low-power optical system for the receiving optical system, the optical system employs a field mirror to distinguish the water surface and underwater echo design by comprehensively considering the advantages and disadvantages of various optical paths and the actual needs of this application, as shown in FIG. 3.

The optical system employs a Kepler transmissive long-path optical system with a primary lens diameter of 110 mm, and links include a water surface detection link and an underwater detection link. The water surface detection link and the underwater detection link are split by the field mirror, in which the field mirror is a mirror with a central hole (that is, a field-splitting mirror), which is located at the focal point of the primary lens, and beneficial to reducing the size of the central hole, thus reducing a receiving loss of the underwater detection link.

### 1.2. Analysis of Optical Receiving System Devices:

The optical receiving system is mainly composed of a Kepler beam-expanding telescope group, a field mirror, a focusing lens and other devices.

The Kepler beam-expanding telescope group is composed of an aspheric primary lens and a spherical collimating lens. The selected primary optical receiving lens has an effective aperture of 110 mm and a focal length of 200 mm, the collimating lens has an effective aperture of 20 mm and a focal length of 25 mm, and the collimating lens forms the Kepler beam-expanding telescope group having a beam-expanding ratio of 8 with the primary lens. A water surface focusing lens has an effective aperture of 20 mm and a focal length of 12.5 mm, and has an effective focal length of about 100 mm after being combined with the telescope group. An underwater focusing lens has an effective aperture of 20 mm and a focal length of 50 mm, and has an effective focal length of about 400 mm after being combined with the telescope group. The effective aperture of the field mirror is elliptical, with an outer dimension of (long axis) 5.66 mm×(short axis) 4 mm, a middle aperture of (long axis) 1.97 mm×(short axis) 1.39 mm, and a silver film and protective silver film coated on the surface.

### 1.3. Simulation of Optical Receiving System:

According to a schematic diagram of the receiving optical system and the analysis of above design parameters, the optical design software Zemax can be configured to simulate the receiving optical system.

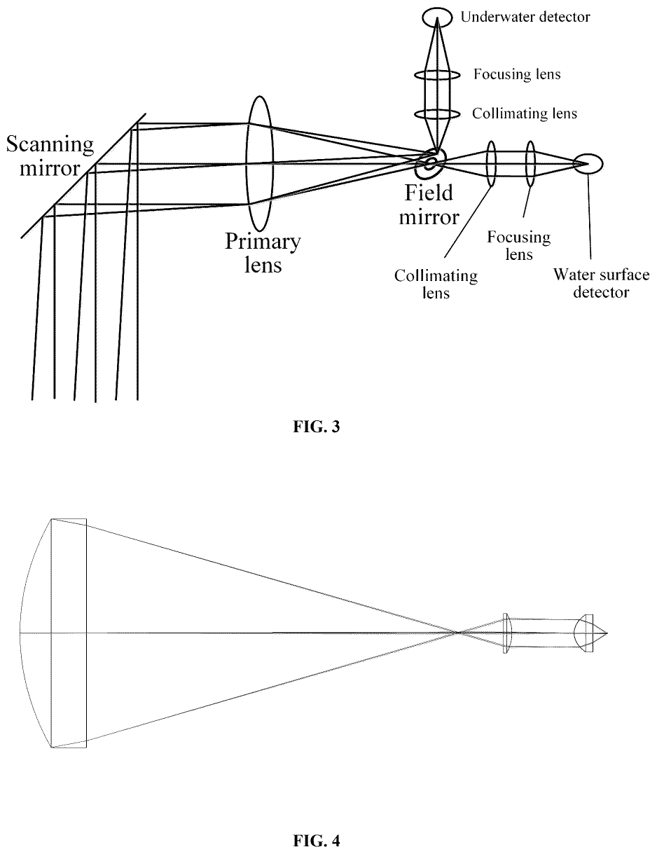

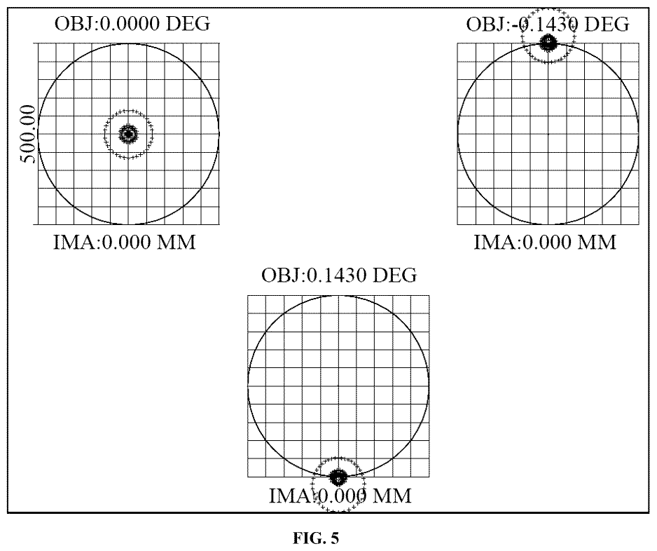

As the photosensitive surface of the water surface detector is small, which is about 0.5 mm, and the receiving field of view is required to be less than or equal to 5 mrad. After optical simulation, a water surface detection receiving optical system has an aperture of 110 mm, and a focal length of about 101 mm, and thus a receiving field of view of the water surface detection receiving optical system is 0.5 mm/101 mm=4.95 mrad, which meets the requirement that the receiving field of view of the water surface detection receiving optical system is less than or equal to 5 mrad. FIG. 4 and FIG. 5 show a simulation diagram of a water surface detection receiving optical system, and a simulation diagram of a receiving field of view, respectively.

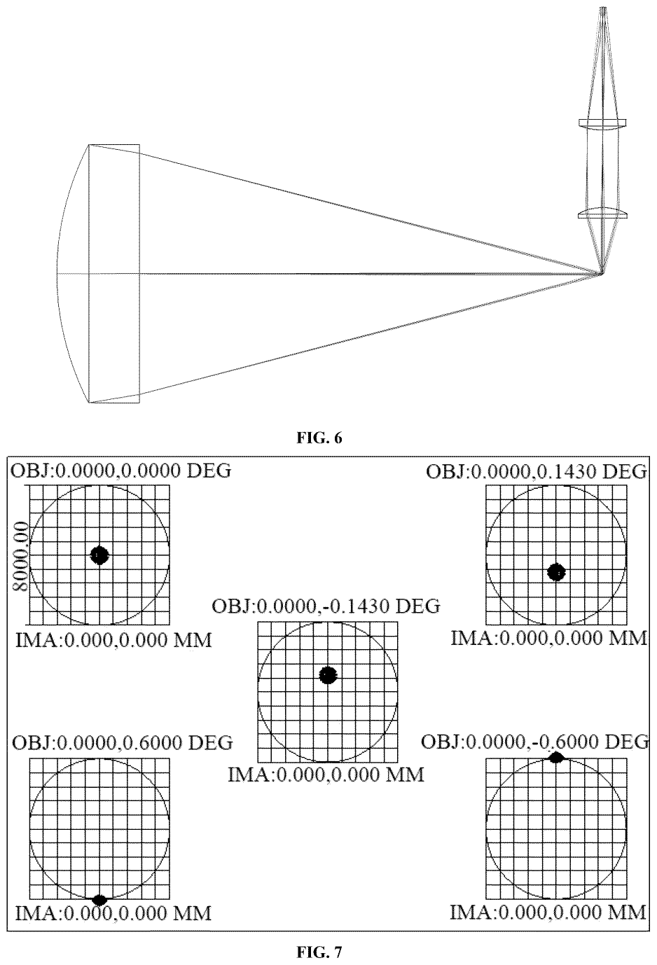

As the photosensitive surface of the underwater detector is large, which is about Φ8 mm, and the receiving field of view is required to be 5 mrad to 21 mrad. After optical simulation, the water surface detection receiving optical system has an aperture of Φ110 mm, and a focal length of about 426 mm, and thus a receiving field of view of the water surface detection receiving optical system is 8 mm/426 mm=18.8 mrad, the size of the center elliptical hole of the field mirror is (long axis) 1.97 mm×(short axis) 1.39 mm, and a focal length of the primary lens is 200 mm. If a field of view angle of the reflected light of the field mirror is more than or equal to 1.39 mm/200 mm=6.9 mrad, a receiving field of view of the underwater detector ranges from 6.9 mrad to 18.8 mrad, which meets the requirement that the receiving field of view of the underwater detection receiving optical system ranges from 5 mrad to 21 mrad. FIG. 6 and FIG. 7 show a simulation diagram of an underwater detection receiving optical system and a simulation diagram of a receiving field of view, respectively.

1.4. Replacement of Field Mirror (Field-Splitting Mirror) with Special Fiber Bundle

According to the parameter design of the optical receiving system in this example, the size of the elliptical shape of the field mirror is (long axis) 5.66 mm×(short axis) 4 mm, and the size of the central elliptic aperture is (long axis) 1.97 mm×(short axis) 1.39 mm; and parameters selected for the fabrication of the input end of the special fiber bundle are as follows: a diameter of the central fiber bundle is Φ1.39 mm, the fiber bundle around the central fiber bundle has an inner diameter of Φ1.39 mm, and an outer diameter of Φ4 mm.

In conclusion, the present disclosure has the following beneficial effects:
(1) Benefiting from the “relay” function of the special fiber bundle, the primary optical lens, a small-field-of-view optical receiving component and a large-field-of-view optical receiving component are relatively independent and can be installed, debugged and reassembled, respectively. Such a separated design enables the alignment and adjustment process easier and can reduce the technical difficulty.
(2) The flexibility of the special fiber bundle allows the flexible design of the length and installation position of the fiber bundle according to the demands of the whole machine. Therefore, optical axes of the large-field-of-view optical receiving component and the small-field-of-view optical receiving component serving as independent units need not be coaxial with the primary optical receiving lens or perpendicular to the optical axis of the primary lens, and the large-field-of-view optical receiving component and the small-field-of-view optical receiving component can be flexibly installed at any position inside the whole machine, thus optimizing the utilization of the internal space of the whole lidar.
(3) The optical echo signals from the large field of view and the small field of view are coupled into the photodetectors from the output ends B and A of the special fiber bundle, respectively. By means of the conventional techniques of commercially available fiber collimators in the field of optical communications, the selection of commercially optical collimating lenses, optical filters, and light focusing lenses with smaller clear apertures is conducive to reducing costs and achieving the miniaturization of the system.
(4) Due to the limitations of the numerical aperture in fiber transmission, the optical signals greater than an angle of field of view of the fiber cannot be transmitted in the fiber. As long as the design of the numerical aperture of the primary optical receiving lens is compatible with the selected numerical aperture of the special fiber bundle, and each of the large and small-field-of-view optical receiving components employs a barrel-enclosed extinction structure, the whole light receiving system will not be disturbed by any stray light outside the set light receiving field of view (i.e., the field of view larger than 35 mrad).
(5) The lightweight and reduction of volume of the large and small-field-of-view optical receiving components are conducive to entire lightweight and miniaturization of the lidar system.

The technical features of the above embodiments can be combined at will. To make the description concise, not all possible combinations of the technical features in the above embodiments are described. However, it should be considered that these combinations of technical features fall within the scope recorded in this specification provided that these combinations of technical features do not have any conflict.

Specific examples are used herein for illustration of the principles and embodiments of the present disclosure. The description of the embodiments is merely used to help illustrate the method and its core principles of the present disclosure. In addition, a person of ordinary skill in the art can make various modifications in terms of specific embodiments and scope of application in accordance with the teachings of the present disclosure. In conclusion, the content of this specification shall not be construed as a limitation to the present disclosure.

1. An optical receiving system based on a special fiber bundle, comprising a primary optical receiving lens, the special fiber bundle, a small-field-of-view optical receiving component, and a large-field-of-view optical receiving component;
wherein the special fiber bundle comprises an input end, a first output end, and a second output end;
the input end is composed of a central multimode fiber, and an annular multimode fiber bundle surrounding the central fiber; the first output end is the central multimode fiber, and the second output end is a circular fiber bundle formed by the annular multimode fiber bundle from the input end;
a center of the input end of the special fiber bundle is located at a focal point of the primary optical receiving lens;
the first output end of the special fiber bundle is connected to the small-field-of-view optical receiving component; and
the second output end of the special fiber bundle is connected to the large-field-of-view optical receiving component.

2. The optical receiving system based on the special fiber bundle according to claim 1, wherein the small-field-of-view optical receiving component comprises a first collimating lens, a first optical filter, a first focusing lens, and a first photodetector in turn along an optical path direction.

3. The optical receiving system based on the special fiber bundle according to claim 1, wherein the large-field-of-view optical receiving component comprises a second collimating lens, a second optical filter, a second focusing lens and a second photodetector in turn along an optical path direction.

4. The optical receiving system based on the special fiber bundle according to claim 1, wherein the central multimode fiber is a single multimode fiber, or a multimode fiber bundle.

5. The optical receiving system based on the special fiber bundle according to claim 4, wherein when the central multimode fiber is the single multimode fiber, a core diameter of the multimode fiber ranges from 200 μm to 500 μm.

6. The optical receiving system based on the special fiber bundle according to claim 4, wherein when the central multimode fiber is the multimode fiber bundle, a core diameter of each multimode fiber in the multimode fiber bundle ranges from 100 μm to 300 μm, and multimode fibers in the multimode fiber bundle have a same core diameter.

7. The optical receiving system based on the special fiber bundle according to claim 1, wherein a core diameter of each multimode fiber in the annular multimode fiber bundle ranges from 100 μm to 300 μm, and multimode fibers in the annular multimode fiber bundle have a same core diameter.

8. The optical receiving system based on the special fiber bundle according to claim 1, wherein the central multimode fiber and multimode fibers in the annular multimode fiber bundle are made of quartz glass.

9. A lidar based on the optical receiving system based on the special fiber bundle according to claim 1, comprising an optical receiving system, wherein
the optical receiving system employs the special fiber bundle, the first output end of the special fiber bundle is coupled to an optical receiving component of a small-field-of-view channel, and the second output end of the special fiber bundle is coupled to an optical receiving component of a large-field-of-view channel.

10. The lidar according to claim 9, wherein the small-field-of-view optical receiving component comprises a first collimating lens, a first optical filter, a first focusing lens, and a first photodetector in turn along an optical path direction.

11. The lidar according to claim 9, wherein the large-field-of-view optical receiving component comprises a second collimating lens, a second optical filter, a second focusing lens and a second photodetector in turn along an optical path direction.

12. The lidar according to claim 9, wherein the central multimode fiber is a single multimode fiber, or a multimode fiber bundle.

13. The lidar according to claim 12, wherein when the central multimode fiber is the single multimode fiber, a core diameter of the multimode fiber ranges from 200 μm to 500 μm.

14. The lidar according to claim 12, wherein when the central multimode fiber is the multimode fiber bundle, a core diameter of each multimode fiber in the multimode fiber bundle ranges from 100 μm to 300 μm, and multimode fibers in the multimode fiber bundle have a same core diameter.

15. The lidar according to claim 9, wherein a core diameter of each multimode fiber in the annular multimode fiber bundle ranges from 100 μm to 300 μm, and multimode fibers in the annular multimode fiber bundle have a same core diameter.

16. The lidar according to claim 9, wherein the central multimode fiber and multimode fibers in the annular multimode fiber bundle are made of quartz glass.
